(19) United States
(12) Patent Application Publication
(10) Pub. No.: US 2004/0030681 A1
(43) Pub. Date: Feb. 12, 2004

(54) System and process for network site fragmented search

(76) Inventors: Paul Thurmond Shannon, Seattle, WA (US); Brad Steven Miller, Mercer Island, WA (US); Scott Chao-Chueh Lee, Bellevue, WA (US); Jennifer Lynn Kolar, Seattle, WA (US)

Correspondence Address: Joseph S Tripoli, Thomson Multimedia Licensing Inc, P O Box 5312, Princeton, NJ, 08543-5312, US

(21) Appl. No.: 10/432,258

(22) PCT Filed: Nov. 20, 2001
(86) PCT No.: PCT/US01/43303

(30) Foreign Application Priority Data
Nov. 21, 2000 (US) 60252273

(51) Int. Cl. G06F 7/00

(52) U.S. Cl. 707/3

(57) ABSTRACT

A system and method for searching a network for target content, such as media files, decompose encountered web pages into frafments (218). Each fragment is searched for character patterns, which relate to the target content (220). The results of each fragment search are combined (226) to provide network-based search results to a user, agent, and/or system (228). The system and method search a network in a more efficient manner, and utilize less memory and processing resources, than prior art search engines and/or agents. This is especially applicable to target content that comprises streaming media, multimedia, and metadata related thereto, because of the large amounts of data that are processed.

The field of this invention relates generally to computer related information search and retrieval, and more specifically to a fragmented search of content on a network.

As background to understanding the invention, an aspect of the Internet (also referred to as the World Wide Web, or Web) contributing to its popularity is the plethora of multimedia and streaming media files available to users. However, finding a specific multimedia or streaming media file buried among the millions of files on the Web is often an extremely difficult task. The volume and variety of informational content available on the web is likely to continue to increase at a rather substantial pace. This growth, combined with the highly decentralized nature of the web, creates substantial difficulty in locating particular informational content.

Streaming media refers to audio, video, multimedia, textual, and interactive data files that are delivered to a user's computer via the Internet or other network environment and begin to play on the user's computer before delivery of the entire file is completed. One advantage of streaming media is that streaming media files begin to play before the entire file is downloaded, saving users the long wait typically associated with downloading the entire file. Digitally recorded music, movies, trailers, news reports, radio broadcasts and live events have all contributed to an increase in streaming content on the Web. In addition, less expensive high-bandwidth connections such as cable, DSL and T1 are providing Internet users with speedier, more reliable access to streaming media content from news organizations, Hollywood studios, independent producers, record labels and even home users.

A user typically searches for specific information on the Internet via a search engine. A search engine comprises a set of programs accessible at a network site within a network, for example a local area network (LAN) or the Internet and World Wide Web. One program, called a “robot” or “spider”, pre-traverses a network in search of documents (e.g., web pages) and other programs, and builds large index files of keywords found in the documents. Typically, a user formulates a query comprising one or more search terms and submits the query to another program of the search engine. In response, the search engine inspects its own index files and displays a list of documents that match the search query, typically as hyperlinks. The user may then activate one of the hyperlinks to see the information contained in the document.

Search engines, however, have drawbacks. For example, many typical search engines are oriented to discover textual information only. In particular, they are not well suited for indexing information contained in structured databases (e.g. relational databases), voice related information, audio related information, multimedia, and streaming media, etc. Also, mixing data from incompatible data sources is difficult for conventional search engines.

Furthermore, when a search engine searches a network, it typically conducts the search in a random fashion by following the web links it encounters. Then, each web site is searched, as a single entity, for queried-related information. This inefficient type of search often generates a large amount of data, which is unnecessary for the use of generating a searchable index. Also, searching each web site as a single entity requires a substantial amount of memory and processing resources. This is especially applicable to objects such as streaming media.

To summarize the invention, a system and method for searching a network for target content, wherein the network contains web pages, decomposes each encountered web page into fragments and searches each fragment for content related to the target content.

### BRIEF DESCRIPTION OF THE DRAWINGS

The invention is best understood from the following detailed description when read in connection with the accompanying drawing. The various features of the drawings may not be to scale. Included in the drawing are the following figures:

FIG. 1 is a stylized overview illustration of a system of interconnected computer system networks; and

FIG. 2 is a flow diagram of an exemplary process for searching a network-based web page for target content in accordance with an embodiment of the present invention.

The Internet is a worldwide system of computer networks that is a network of networks in which users at one computer can obtain information from any other computer and communicate with users of other computers. The most widely used part of the Internet is the World Wide Web (often-abbreviated “WWW” or called “the Web”). An outstanding feature of the Web is its use of hypertext, which is a method of cross-referencing. In most Web sites, certain words or phrases appear in text of a different color than the surrounding text. This text is often also underlined. Sometimes, there are buttons, images or portions of images that are “clickable.” Using the Web provides access to millions of pages of information. Web “surfing” is done with a Web browser; such as NETSCAPE NAVIGATOR® and MICROSOFT INTERNET EXPLORER®. The appearance of a particular website may vary slightly depending on the particular browser used. Recent versions of browsers have “plug-ins,” which provide animation, virtual reality, sound and music.

The present invention is a system and method for retrieving network based content, including media files and data related to media files, on a computer network via a search system utilizing metadata. As used herein, the term “media file” includes audio, video, textual, multimedia data files, and streaming media files. Multimedia files comprise any combination of text, image, video, and audio data. Streaming media comprises audio, video, multimedia, textual, and interactive data files that are delivered to a user's computer via the Internet or other communications network environment and begin to play on the user's computer/ device before delivery of the entire file is completed. One advantage of streaming media is that streaming media files begin to play before the entire file is downloaded, saving users the long wait typically associated with downloading the entire file. Digitally recorded music, movies, trailers, news reports, radio broadcasts and live events have all contributed to an increase in streaming content on the Web. In addition, the reduction in cost of communications networks through the use of high-bandwidth connections such as cable, DSL, T1 lines and wireless networks (e.g., 2.5G or 3G based cellular networks) are providing Internet users with speedier, more reliable access to streaming media content from news organizations, Hollywood studios, independent producers, record labels and even home users themselves.

Examples of streaming media include songs, political speeches, news broadcasts, movie trailers, live broadcasts, radio broadcasts, financial conference calls, live concerts, web-cam footage, and other special events. Streaming media is encoded in various formats including REALAUDIO®, REALVIDEO®, REALMEDIA®, APPLE QUICKTIME®, MICROSOFT WINDOWS® MEDIA FORMAT, QUICKTIME®, MPEG-2 LAYER III AUDIO, and MP3®. Typically, media files are designated with extensions (suffixes) indicating compatibility with specific formats. For example, media files (e.g., audio and video files) ending in one of the extensions, ram, .rm, .rpm, are compatible with the REALMEDIA® format. Some examples of file extensions and their compatible formats are listed in the following table. A more exhaustive list of media types, extensions and compatible formats may be found at http://www.bowers.cc/extensions2.htm.

TABLE 1

| Format | Extension |
|---|---|
| REALMEDIA ® | .ram, .rm, .rpm |
| APPLE QUICKTIME ® | .mov, .qif |
| MICROSOFT | .wma, .cmr, .avi |
| WINDOWS ® MEDIA | |
| PLAYER | |
| MACROMEDIA FLASH | .swf, .swl |
| MPEG | .mpg, .mpa, .mp1, |
| | .mp2 |
| MPEG-2 LAYER III | .mp3, .m3a, .m3u |
| Audio | |

Metadata as descriptive data literally means “data about data.” Metadata is data that comprises information that describes the contents or attributes of other data (e.g., media file). For example, a document entitled, “Dublin Core Metadata for Resource Discovery,” (http://www.ietf.org/rfc/rfc2413.txt) separates metadata into three groups, which roughly indicate the class or scope of information contained therein. These three groups are: (1) elements related primarily to the content of the resource, (2) elements related primarily to the resource when viewed as intellectual property, and (3) elements related primarily to the instantiation of the resource. Examples of metadata falling into these groups are shown in the following table.

TABLE 2

| | Intellectual | |
|---|---|---|
| Content | Property | Instantiation |
| Title | Creator | Date |
| Subject | Publisher | Format |
| Description | Contributor | Identifier |
| Type | Rights | Language |
| Source | | |
| Relation | | |
| Coverage | | |

Sources of metadata include web page content, uniform resource indicators (URIs), media files, and transport streams used to transmit media files. Web page content includes HTML, XML, metatags, and any other text on the web page. As explained in more detail, herein, metadata may also be obtained from the URLs the web page, media files, and other metadata. Metadata within the media file may include information contained in the media file, such as in a header or trailer, of a multimedia or streaming file, for example. Metadata may also be obtained from the media/metadata transport stream, such as TCP/IP (e.g., packets), ATM, frame relay, cellular based transport schemes (e.g., cellular based telephone schemes), MPEG transport, HDTV broadcast, and wireless based transport, for example. Metadata may also be transmitted in a stream in parallel or as part of the stream used to transmit a media file (a High Definition television broadcast is transmitted on one stream and metadata, in the form of an electronic programming guide, is transmitted on a second stream).

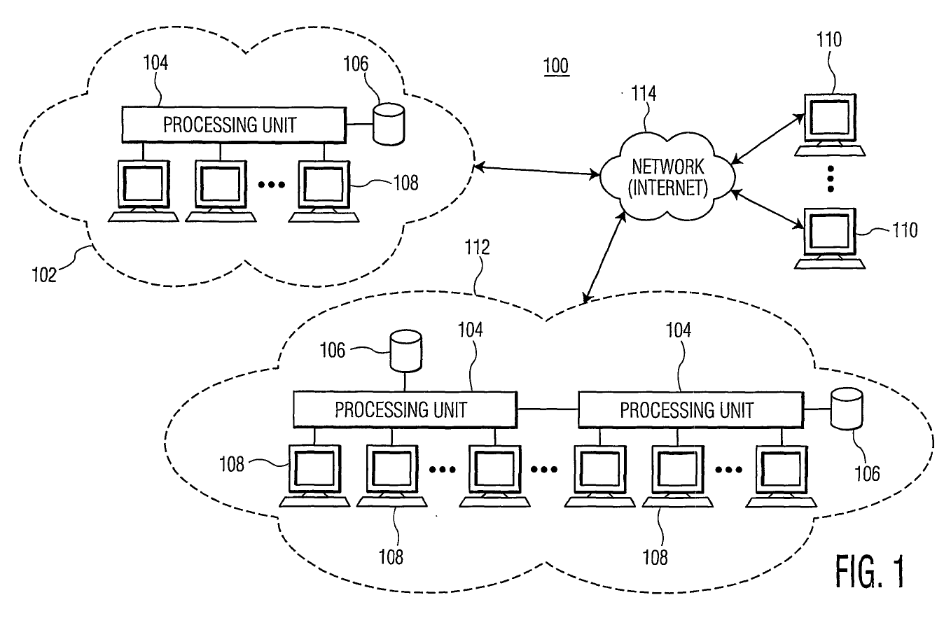

Referring to FIG. 1 there is shown a stylized overview of a system 100 of interconnected computer system networks 102 and 112. Each computer system network 102 and 112 contains at least one corresponding local computer processor unit 104 (e.g., server), which is coupled to at least one corresponding local data storage unit 106 (e.g., database), and local network users 108. A computer system network as a communications network may be a local area network (LAN) 102 or a wide area network (WAN) 112, for example. The local computer processor units 104 are selectively coupled to a plurality of media devices 110 through the network (e.g., Internet) 114. Each of the plurality of local computer processors 104, the network user processors 108, and/or the media devices 110 may have various devices connected to its local computer systems, such as scanners, bar code readers, printers, and other interface devices. A local computer processor 104, network user processor 108, and/or media device 110, programmed with a Web browser, locates and selects (e.g., by clicking with a mouse) a particular Web page, the content of which is located on the local data storage unit 106 of a computer system network 102, 112, in order to access the content of the Web page. The Web page may contain links to other computer systems and other Web pages.

The local computer processor 104, the network user processor 108, and/or the media device 110 may be a computer terminal, a pager which can communicate through the Internet using the Internet Protocol (IP), a Kiosk with Internet access, a connected electronic planner (e.g., a PALM device manufactured by Palm, Inc.) or other device capable of interactive communication through a network, such as an electronic personal planner. The local computer processor 104, the network user processor 108, and/or the media device 110 may also be a wireless device, such as a hand held unit (e.g., cellular telephone) that connects to and communicates through the Internet using the wireless access protocol (WAP). Networks 102 and 112 may be connected to the network 114 by a modem connection, a Local Area Network (LAN), cable modem, digital subscriber line (DSL), twisted pair, wireless based interface (cellular, infrared, radio waves), or equivalent connection utilizing data signals. Databases 106 may be connected to the local computer processor units 104 by any means known in the art. Databases 106 may take the form of any appropriate type of memory (e.g., magnetic, optical, etc.). Databases 106 may be external memory or located within the local computer processor 104, the network user processor 108, and/or the media device 110.

Computers may also encompass computers embedded within consumer products and other computers. For example, an embodiment of the present invention may comprise computers (as a processor) embedded within a television, a set top box, an audio/video receiver, a CD player, a VCR, a DVD player, a multimedia enable device (e.g., telephone), and an Internet enabled device.

In an exemplary embodiment of the invention, the network user processors 108 and/or media devices 110 include one or more program modules and one or more databases that allow user processors 108 and/or media devices 110 to communicate with the local processor 104, and each other, over the network 114. The program module(s) include program code, written in PERL, Extensible Markup Language (XML), Java, Hypertext Mark-up Language (HTML), or any other equivalent language which allows the network user processors 108 to access the program module(s) of the local processors 104 through the browser programs stored on the network user processors 108.

Web sites and web pages are locations on a network, such as the Internet, where information (content) resides. A web site may comprise a single or several web pages. A web page, as a media object, is identified by a Uniform Resource Indicator (URI) comprising the location (address) of the web page on the network. Examples of URIs are Uniform Resource Locators (URLs), Internet addresses, and other identifying indicia well known in the art. Web sites, and web pages, may be located on local area network 102, wide area network 112, network 114, processing units (e.g., servers) 104, user processors 108, and/or media devices 110. Information, or content, may be stored in any storage device, such as a hard drive, compact disc, and mainframe device, for example. Content may be stored in various formats, which may differ, from web site to web site, and even from web page to web page.

When a search query is provided to a system in accordance with the present invention, web pages are searched for target content. More specifically, databases that have been pre-compiled (i.e., compiled prior to the entry of the search query) by agents of a search engine, such as spiders, are searched for terms and other web pages related to the target content. Target content is content related to the search query. For example, assume a user provides a search query containing a request for “Elvis Presley”. Example types of target content generated by the system include streaming media files, multimedia files, audio files, image files, links to other web pages, metadata related to the search query and/or target content, and any combination thereof. Furthermore, when processing a search query, the system utilizes metadata to aid in the search. Previously, when searching content on a web page, the entire web page was searched as a single entity. This often required an excessive amount of memory and processing resources to maintain all the data (e.g., metadata) found on the web page needed to conduct the search. This was exacerbated when the search query and/or target content comprised multimedia and/or streaming media, because multimedia and streaming media typically comprise large amounts of metadata.

The inventors have discovered a technique for efficiently searching a network. Briefly, an encountered network page (e.g., web page) is decomposed into fragments. Each fragment is searched for character patterns, which relate to the target content (e.g., streaming media, media files, metadata, links). Each fragment is recursively searched for further fragments, which may, in turn, be searched. The results of each fragment search are combined, wherein discovered content related to the target content (e.g. streaming media links, other pages) are utilized to aid in the search process.

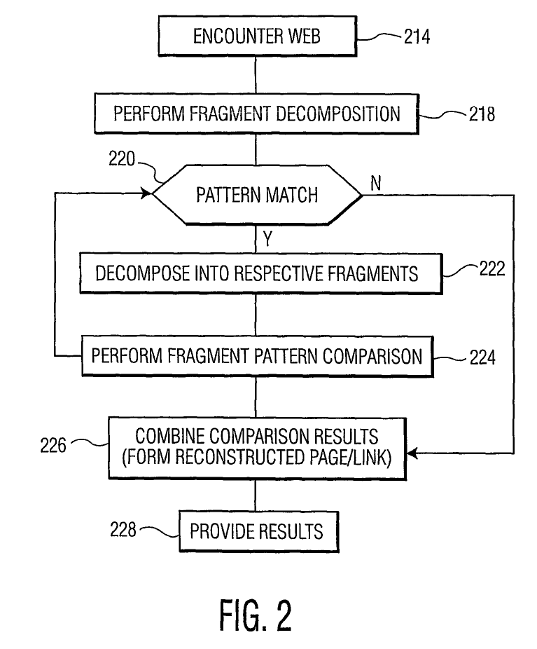

FIG. 2 is a flow diagram of an exemplary process for searching a network-based web page for target content in accordance with an embodiment of the present invention. A search query is provided by a user, a system, or agent. Target content is generated in accordance with the search query. In one embodiment of the invention, target content is generated in accordance with metadata related to the search query and/or target content. A description of a search process utilizing metadata to generate target content is described in related U.S. patent application Ser. No. 09/867,941, entitled “Internet Streaming Media Workflow Architecture”, filed Jun. 8, 2001 or as exemplified by the multimedia search engine located at http://www.singingfish.com. Examples of target content include multimedia objects, multimedia files, streaming media files, image files, audio files, metadata related to the search query and/or target content, historical data related to the search query an/or target content, and any combination thereof.

A further explanation of a search process utilizing metadata is demonstrated in reference to Table 3, displayed below. The workflow process shown in Table 3 has four components: Crawling, Extracting, Enhancement, and Grouping. The Crawling segment, for example performed by a web crawler, crawls a communications network as the Internet to locate web pages and data storage archives comprising targeted content (as explained above). The web crawler then Extracts metadata relating to the targeted content, which typically entails transferring the extracted metadata to a database. The workflow process follows with the Enhancement of extracted metadata stored in the database with processes such as annotating the extracted metadata with metadata from other databases and sources of valid metadata entries. The Grouping step completes the process with manipulating the enhanced metadata into groups by processes as eliminating repetitive metadata entries, and grouping together enhanced metadata with similar fields.

TABLE 3
Workflow

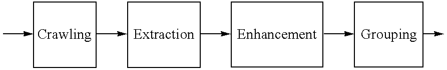

The network (e.g., the Internet) is searched for content related to the target content. The network may be searched in accordance with processes used in conventional search engines and agents. The network may also be searched utilizing metadata related to the search query and/or target content, historical data related to the search query and/or target content, and any combination thereof. A description of a process for searching a network utilizing metadata and/or historical data related to the search query and/or target content is described in related U.S. patent application Ser. No. 09/867,941, entitled “Internet Streaming Media Workflow Architecture”, filed Jun. 8, 2001 or as exemplified by the multimedia search engine located at http://www.singingfish.com.

During the search process, web pages are encountered at step 214. Each encountered web page is decomposed into fragments at step 218. Fragment decomposition comprises comparing textual data contained on the web page with predetermined or dynamically determined textual patterns. The patterns are related to the target content. In an exemplary embodiment of the invention, patterns are related to streaming media, multimedia, metadata related to streaming media, metadata related to multimedia, links to other web pages, and any combination thereof. The predetermined patterns are heuristically determined in accordance with the type of target content. The dynamically determined patterns result from elements discovered on the encountered web page being searched. Thus, patterns may differ for different types of target content. For example, the set of patterns for streaming media files may differ from the set of patterns for image files. Patterns comprise at least one character related to target content. Examples of patterns include characters such as the symbols “<”, and “>”; tags such as “area”, “param”, and “meta”; the terms “http” and “function play clip”; and various combination of thereof.

The number of characters contained in the various predetermined patterns differs. The number of characters (length) of a pattern is determined in accordance with heuristically determined termination conditions. For example, a pattern may comprise all characters in a string of characters starting with the tag “area” and ending with the first right angle bracket “>” encountered in the string of characters. Another example is a pattern comprising all characters in a string starting with the tag “param” and ending with the first right angle bracket “>” encountered in the string.

In accordance with the present invention, a fragment is generated for each pattern found on the web page (step 222). That is, the content of the web page is compared with the set of predetermined patterns, at step 220, and for each pattern found on the web page that matches a predetermined pattern, a respective fragment is formed at step 222. A fragment may comprise a single pattern, or a plurality of patterns, found on the web page. As explained previously, pattern lengths differ. Thus, any particular pattern may comprise another pattern(s). Accordingly, at step 224, each fragment is compared with predetermined patterns. If any pattern matches are found (step 220) in the fragment, more respective fragments are generated. This process is repeated until no more patterns are matched.

If applicable, the comparison results are then combined at step 226. Not all comparison results of the fragment searches need be combined, however, it is not uncommon for search results to include redundant links to URLs (being an example of a URI) and multiple links to the same URL, wherein the URL differs only by a term (such as bit rate, for example). Accordingly, combining the comparison results may comprise removing redundant URLs, adding and/or deleting terms to/from a URL, reorganizing terms in a URL, or any combination thereof. In one embodiment of the invention, metadata related to the search query and/or the target content is utilized to combine the comparison results. A combination process utilizing metadata related to the search query and/or target content is described in related U.S. patent application Ser. No. 09/867,941, entitled “Internet Streaming Media Workflow Architecture”, filed Jun. 8, 2001 or as exemplified by the multimedia search engine located at http://www.singingfish.com. Further, in accordance with the present invention, combining the comparison results comprises forming a reconstructed link or a reconstructed web page. A reconstructed link is a link to another web page that is formed from the patterns, and/or portions of the patterns, contained in the fragments. A reconstructed page is a page that is formed from the patterns, and/or portions of the patterns, contained in the fragments. The rules for forming a reconstructed link/page are heuristically generated. Example rules include using the number of comma delimited values to determine which of several possible variations will be used to generate a media link; and using the presence of another fragment describing possible playback speeds at which a media link is available to generate a set of media links, wherein if that fragment is absent, a default set of speeds is used. The results of the fragment/web page searches are made available to other systems, a user(s), an agent, or any combination thereof at step 228. In one embodiment of the invention, the results are provided to memory, wherein the memory is accessible by other systems/users/agents.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, high density disk, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

A system 100 in accordance with the present invention searches a network for target content in a more efficient manner, and utilizes less memory and processing resources, than prior art search engines and/or agents. By decomposing web pages into fragments and conducting searches on the fragments, patterns are more easily detected because fragments are already classified (in accordance with predetermined and/or dynamically determined patterns). Thus the system may incorporate a smaller set of page link and media link detectors to search for each fragment. Furthermore, for majority of situations, a need to maintain the context of each web page being processed no longer exists, thus further reducing system complexity. Additionally, by decomposing web pages (and fragments) into fragments, many similar tasks that are conventionally performed on each of multiple selected web sites are combined into a single routine that is applied to all web sites. These advantages are especially applicable to target content that comprise streaming media, multimedia, and metadata related thereto, because of the large amounts of data that are processed.

What is claimed is:

1. A method for searching a network for target content, said network comprising web pages, said method comprising the steps of:
decomposing each encountered web page into fragments; and
searching each fragment for content related to said target content.

2. A method in accordance with claim 1, wherein said step of searching is performed recursively to further search each said fragment for content related to said target content.

3. A method in accordance with claim 1, wherein said step of decomposing comprises the steps of:
comparing textual content contained on each web page with at least one of predetermined and dynamically determined textual patterns;
generating a respective fragment for each pattern of textual content contained on each web page that matches a pattern;
recursively comparing textual content contained in each respective fragment with at least one of predetermined and dynamically determined textual patterns; and
generating a respective fragment for each pattern of textual content contained in each fragment that matches a pattern.

4. A method in accordance with claim 3, further comprising the step of forming a reconstructed link, wherein a reconstructed link comprises at least one of a matched pattern and a portion of a matched pattern contained in at least one fragment.

5. A method in accordance with claim 3, wherein said patterns comprise textual data related to at least on of streaming media, multimedia, metadata related to streaming media, metadata related to multimedia, and other web pages.

6. A method in accordance with claim 1, further comprising the step of combining results of said searching each fragment, said results comprising at least one link to a uniform resources indicator (URI), wherein said step of combining comprises at least one of adding, deleting, and reorganizing terms contained within at least one URI.

7. A computer system for searching a network for target content, said network comprising web pages, said computer system comprising at least one computer, all computers in said system being communicatively coupled to each other, wherein each of said at least one computer includes at least one program stored therein for allowing communication between each and every of said at least one computer, each of said at least one program operating in conjunction with one another to cause said at least one computer to perform the steps of:
decomposing each encountered web page into fragments (218); and
searching each fragment for content related to said target content.

8. A system in accordance with claim 7, wherein said step of searching is performed by said at least one computer recursively to further search each said fragment for content related to said target content.

9. A computer system in accordance with claim 7, wherein said at least one program causes said at least one computer to perform the further steps of:
comparing textual content contained on each web page with at least one of predetermined and dynamically determined textual patterns (220);
generating a respective fragment for each pattern of textual content contained on each web page that matches a pattern;
recursively comparing textual content contained in each respective fragment with at least one of predetermined and dynamically determined textual patterns; and
generating a respective fragment for each pattern of textual content contained in each fragment that matches a pattern.

10. A computer system in accordance with claim 9, wherein said at least one program causes said at least one computer to perform the further step of forming a reconstructed link, wherein a reconstructed link comprises at least one of a matched pattern and a portion of a matched pattern contained in at least one fragment.

11. A computer system in accordance with claim 9, wherein said patterns comprise textual data related to at least on of streaming media, multimedia, metadata related to streaming media, metadata related to multimedia, and other web pages.

12. A computer system in accordance with claim 7, wherein said at least one program causes said at least one computer to perform the further step of combining results of said searching each fragment, said results comprising at least one link to a uniform resources indicator (URI), wherein said step of combining comprises at least one of adding, deleting, and reorganizing terms contained within at least one URI.

13. A program readable medium having embodied thereon a program for causing a processor to search network based content for target content, said network comprising web pages, said program readable medium comprising:
means for causing said processor to decompose each encountered web page into fragments; and
means for causing said processor to search each fragment for content related to said target content.

14. A program readable medium in accordance with claim 13, wherein said means for causing said processor to search each fragment is performed recursively to further search each said fragment for content related to said target content.

15. A program readable medium in accordance with claim 13, said program readable medium further comprising:
means for causing said processor to compare textual content contained on each web page with at least one of predetermined and dynamically determined textual patterns;
means for causing said processor to generate a respective fragment for each pattern of textual content contained on each web page that matches a pattern;
means for causing said processor to recursively compare textual content contained in each respective fragment with at least one of predetermined and dynamically determined textual patterns; and
means for causing said processor to generate a respective fragment for each pattern of textual content contained in each fragment that matches a pattern.

16. A program readable medium in accordance with claim 15, said program readable medium further comprising means for causing said processor to form a reconstructed link, wherein a reconstructed link comprises at least one of a matched pattern and a portion of a matched pattern contained in at least one fragment.

17. A program readable medium in accordance with claim 15, wherein said patterns comprise textual data related to at least on of streaming media, multimedia, metadata related to streaming media, metadata related to multimedia, and other web pages.

18. A program readable medium in accordance with claim 13, said program readable medium further comprising means for causing said processor to combine results of said searching each fragment, said results comprising at least one link to a uniform resources indicator (URI), wherein said step of combining comprises at least one of adding, deleting, and reorganizing terms contained within at least one URI.

19. A data signal embodied in a carrier wave comprising:
a decompose web page code segment for searching a network for target content, said network comprising web pages, wherein said decompose web page code segment decomposes each encountered web page into fragments; and
a search fragment code segment for searching each fragment for content related to target content.

20. A data signal in accordance with claim 19, wherein said search fragment code segment for searching is performed recursively to further search each said fragment for content related to said target content.

21. A data signal in accordance with claim 19, further comprising:
a compare web page code segment for comparing textual content contained on each web page with at least one of predetermined and dynamically determined textual patterns;
a generate fragment code segment for generating a respective fragment for each pattern of textual content contained on each web page that matches a pattern;
a compare fragment code segment for recursively comparing textual content contained in each respective fragment with at least one of predetermined and dynamically determined textual patterns; and
said generate fragment code segment for generating a respective fragment for each pattern of textual content contained in each fragment that matches a pattern.

22. A data signal in accordance with claim 21, further comprising a form reconstructed link code segment for forming a reconstructed link, wherein a reconstructed link comprises at least one of a matched pattern and a portion of a matched pattern contained in at least one fragment.

23. A data signal in accordance with claim 21, wherein said patterns comprise textual data related to at least on of streaming media, multimedia, metadata related to streaming media, metadata related to multimedia, and other web pages.

24. A data signal in accordance with claim 19, further comprising a combine code segment for combining results of said searching each fragment, said results comprising at least one link to a uniform resources indicator (URI), wherein said step of combining comprises at least one of adding, deleting, and reorganizing terms contained within at least one URI.
